(19) United States
(12) Patent Application Publication
(10) Pub. No.: US 2018/0089937 A1
(43) Pub. Date: Mar. 29, 2018

(54) Wireless Remote Control Unit for Wager Game

(71) Applicant: Digital Gaming Corporation Limited, London (GB)

(72) Inventors: Douglas Wilson, Durban (ZA); Bren Newman, Cape Town (ZA); Ken Jarvis, London (GB); Stafford Masie, Johannesburg (ZA)

(21) Appl. No.: 15/679,780

(22) Filed: Aug. 17, 2017

Related U.S. Application Data
(60) Provisional application No. 62/399,884, filed on Sep. 26, 2016.

(51) Int. Cl. G07F 17/32; H04L 29/08

(52) U.S. Cl. CPC G07F 17/3223; G07F 17/3244; G07F 17/3211; H04L 67/04; G07F 17/3262; G07F 17/3288; G07F 17/323

(57) ABSTRACT

An embodiment may involve a wireless remote control unit that comprises a wireless communication interface, an input device, a display, a processing unit, and data storage comprising instructions executable by the processing unit to carry out various operations. The operations include (i) establishing communication with an electronic gaming machine using the wireless communication interface, (ii) displaying on the display at least one game-play option for a particular wager game on the electronic gaming machine, (iii) receiving via the input device data indicative of a game-play command for the particular wager game, and (iv) sending to the electronic gaming machine, via the wireless communication interface, instructions for carrying out the game-play command.

### CROSS-REFERENCE TO RELATED APPLICATIONS

This application claims the benefit of U.S. Provisional Application No. 62/399,884 filed on Sep. 26, 2016, the entirety of which is herein incorporated by reference.

### BACKGROUND

This disclosure relates to gaming machines for playing games such as wager games.

Wager games can be played on a variety of electromechanical and electronic devices. An electro-mechanical slot machine may include one or more reels, each of which includes multiple symbols distributed around the circumference of the reel. When a player places a wager (e.g., by placing a coin in the machine), the player is allowed to spin the reels. Each reel then comes to rest, typically with either one of the symbols, or a space in between symbols, in alignment with a pay line. A predefined winning symbol or a predefined winning combination of symbols that are aligned with the pay line can result in the player winning the game and receiving a payout. In one example, the machine may include three reels, and the pay line may be a horizontal line disposed across a center of each of the three reels.

An electronic gaming machine may include a graphical user interface (GUI) that emulates an electro-mechanical slot machine. With an electronic gaming machine, the GUI may include a display that displays an image of one or more reels or a matrix as described above, together with animation effects to simulate a spin of the one or more reels, or a spin of the columns or rows of the matrix. A computer software program, which may reside in the electronic gaming machine, may randomly select one or more symbols in response to a spin, and may display the selected one or more symbols on the display.

A GUI of an electronic gaming machine may include one or more input components that allow a user (e.g., a player of a wager game) to interact with an electronic gaming machine. For instance, the GUI may include a button panel that is physically attached to the electronic gaming machine. The button panel may include one or more physical buttons or a touch-sensitive screen configured to display one or more virtual buttons. The user can make a wager or spin a reel(s) using the button panel.

### SUMMARY

Example embodiments are described herein. Viewed from a first aspect, the disclosure provides a wireless remote control unit that comprises a wireless communication interface, an input device, a display, a processing unit, and data storage comprising instructions executable by the processing unit to carry out various operations. The operations include (i) establishing communication with an electronic gaming machine using the wireless communication interface, (ii) displaying on the display at least one game-play option for a particular wager game on the electronic gaming machine, (iii) receiving via the input device data indicative of a game-play command for the particular wager game, and (iv) sending to the electronic gaming machine, via the wireless communication interface, instructions for carrying out the game-play command.

Viewed from a second aspect, the disclosure provides a system comprising a display device, an electronic gaming machine configured to run one or more wager games, and a wireless remote control unit. The electronic gaming machine is configured to generate image data for display on the display device for the one or more wager games, and the electronic gaming machine comprises a wireless communication interface. The wireless remote control unit comprises a wireless communication interface, an input device, and a remote control unit display. The wireless remote control unit is configured to: (i) display on the remote control unit display at least one game-play option for a particular wager game on the electronic gaming machine, (iii) receive via the input device data indicative of a game-play command for the particular wager game, and (iii) send to the electronic gaming machine, via the wireless communication interface of the wireless remote control unit, instructions for carrying out the game-play command.

Viewed from a third aspect, the disclosure provides a method for playing a wager game. The method involves establishing communication with an electronic gaming machine using a wireless communication interface of a wireless remote control unit, with the electronic gaming machine being configured to run the wager game. The method also involves displaying on a display of the wireless remote control unit at least one game-play option for the wager game. Further, the method involves receiving via an input device of the wireless remote control unit data indicative of a game-play command for the particular wager game. Still further, the method involves sending to the electronic gaming machine, via the wireless communication interface, instructions for carrying out the game-play command.

Viewed from a fourth aspect, the disclosure provides an article of manufacture including a non-transitory computer-readable medium, having stored thereon program instructions that, upon execution by a wireless remote control unit, cause the wireless remote control unit to perform the operations of the first aspect.

Viewed from a fifth aspect, the disclosure provides an article of manufacture including a non-transitory computer-readable medium, having stored thereon program instructions that, upon execution by a wireless remote control unit, cause the wireless remote control unit to perform the method of the third aspect.

Viewed from a sixth aspect, the disclosure provides a system comprising means for performing the operations of the first aspect.

Viewed from a seventh aspect, the disclosure provides a system comprising means for performing the method of the third aspect.

In embodiments of the disclosure in which a computer software product is used, the product may be non-transitory and store instructions on physical media such as a DVD, or a solid state drive, or a hard drive. Alternatively, the product may be transitory and in the form of instructions provided over a connection such as a network connection which is linked to a network such as the Internet.

These aspects, as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

FIG. 1 is a schematic representation of an example system, in accordance with example embodiments.

FIG. 2 is a simplified block diagram of an example electronic gaming machine, in accordance with example embodiments.

FIG. 3 is a simplified block diagram of an example wireless remote control unit.

FIG. 4 is a flow chart, in accordance with example embodiments.

### DETAILED DESCRIPTION

### I. Introduction

This description describes several example embodiments including, but not limited to, example embodiments pertaining to a wireless remote control unit and to methods for playing a wager game using a wireless remote control unit.

By way of example, an example system may include a display device, an electronic gaming machine configured to run one or more wager games, and a wireless remote control unit. The electronic gaming machine may be coupled to the display device via a wired or wireless connection. In addition, the electronic gaming machine may be configured to generate image data for display on the display device for the one or more wager games. The wireless remote control unit may take the form of a handheld device used by players to play wager games. The wireless remote control unit may include a wireless communication interface through which the wireless remote control unit may communicate with the electronic gaming machine. Further, the wireless remote control unit may include an input device, and a remote control unit display.

In operation, a user may play the wager game (e.g., make wagers, spin, bet, draw, etc.) using the wireless remote control unit. The remote control unit display may display various game-play options, and the user may select the game-play options via the input device of the wireless remote control unit. For instance, the remote control unit display may display an electronic version of a conventional button panel. As the user plays the wager game, the electronic gaming machine may update the image data provided on the display device.

Advantageously, the wireless remote control unit is portable/mobile. A player can play a wager game in comfort while being seated, lying down, and moving around, at almost any distance using the wireless remote control unit, instead of being confined to a typical electronic gaming machine standing or seating area. For instance, if the display device is a computer monitor in a casino or lounge, a user can take the wireless remote control unit to a chair where the user can sit down and play the wager game, viewing the wager game on the computer monitor from a distance. As another example, if the display device is a television in a hotel room or cruise ship cabin, the user can use the wireless remote control unit to play the wager game from a bed or chair in the hotel room or cruise ship cabin.

In some embodiments, the wireless remote control unit may include an integrated payment machine that allows for wireless financial transactions. With the integrated payment machine, a user can make secure payment transactions to fund a wager game. For instance, the integrated payment machine may be a card reader, and the user may slide or insert a credit card to add funds to the user's wager account. Alternatively, the card reader could support near field communication (NFC) payment, in which case the user may tap an NFC device to the card reader. The integrated payment machine could also facilitate other payment mechanisms, like image/marker/barcode scan. Further, the integrated payment machine could facilitate authentication via thumbprint reading and/or facial recognition.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### II. Example Architecture

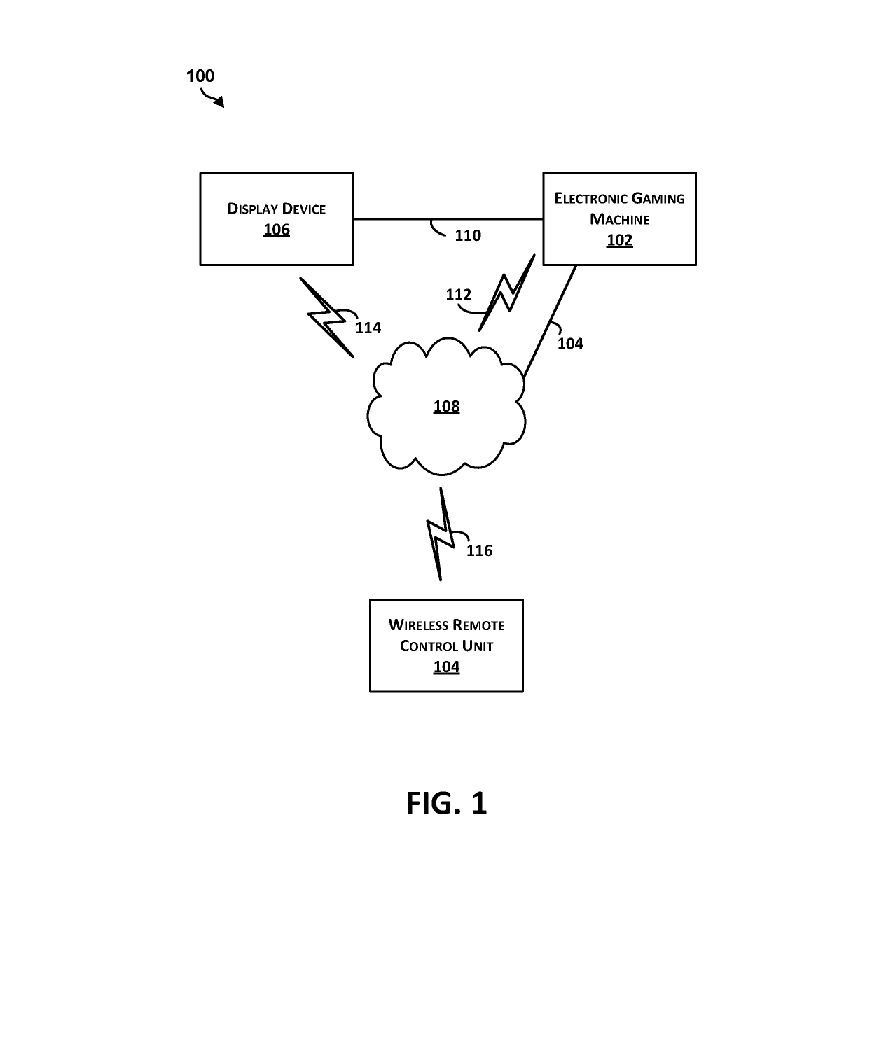

FIG. 1 depicts a schematic representation of an example system 100 in accordance with example embodiments. The system 100 includes an electronic gaming machine 102, a wireless remote control unit 104, a display device 106, and a communications network 108.

The electronic gaming machine 102 may take any of a variety of forms, including for example a dedicated gaming machine, a personal computer, a server computer, or some other computing device. The electronic gaming machine 102 may be configured to store and execute one or more wager games. Examples of wager games include, but are not limited to, slot machine games, poker, blackjack, baccarat, craps, roulette, and wheels of fortune. The wager games may be games which have been certified by governing authorities to be released and played.

In one example, a wager game may be a graphical native application running under on a Windows®-based operating system (e.g., Windows 7 or Windows 10).

As part of executing a wager game, the electronic gaming machine 102 may be configured to generate image data for display on the display device 106 for the wager game. For instance, as shown in FIG. 1, the electronic gaming machine 102 may be coupled to the display device 106 via a wired connection 110 (e.g., HDMI, VGA, etc.). During execution of a slot machine game, the electronic gaming machine 102 may generate image data including representations of one or more reels, and provide the image data to the display device 106 via the wired connection 110 for display.

Alternatively or additionally, the electronic gaming machine 102 may be coupled to the display device 106 via a wireless connection (e.g., Wi-Fi). For instance, the electronic gaming machine 102 may be coupled to the communications network 108 via a wireless connection 112 and the display device 106 may be coupled to the communications network 108 via a wireless connection 114. With this configuration, the electronic gaming machine 102 could send image data to the display device 106 wirelessly via the communications network 108 and using a wireless communication interface.

The display device 106 may be any type of display device, such as a television, computer monitor, or image projector.

The communications network 108 may correspond to a local area network (LAN), a wide area network (WAN), a corporate intranet, the public Internet, or any other type of network configured to provide a communications path between networked computing devices. The communications network 108 may also correspond to a combination of one or more LANs, WANs, corporate intranets, and/or the public Internet. In example, the communications network 108 may be an encrypted wireless network broadcast by the electronic gaming machine 102.

The wireless remote control unit 104 may take any of a variety of forms, including for example, a tablet computer, a wearable computer, a personal digital assistant, or some other computing device. The wireless remote control unit 104 is unattached from the electronic gaming machine and, hence, used to play wager games remotely and wirelessly.

The wireless remote control unit 104 can be battery powered and can include a wireless communication interface that supports one-way or two-way wireless communication with the electronic gaming machine 102 (e.g., direct wireless communication or wireless communication via network 108).

The wireless remote control unit 104 can also include an input device that can receive input from a user. The input device could be, for example, a mechanical button panel, a miniaturized mechanical button panel, or a touchscreen overlaying a display that is configured to display a representation of a button panel. For instance, the wireless remote control unit 104 can be a mobile phone or tablet configured to display a representation of a button panel.

In practice, the wager game is not emulated on the wireless remote control unit 102. Rather, the wager game runs on the electronic gaming machine 102 and is displayed on the display device 106.

In one embodiment, a player can install a software application on a device (e.g., a mobile phone or tablet) which allows the device to function as the wireless remote control unit 104. The software application may be controlled and distributed by a casino. Alternatively or additionally, the software application may be available for download from an application store. If the player downloads the software application from an application store, the player may need to configure and setup private access to the electronic gaming machine 102.

As shown in FIG. 1, the wireless remote control unit 104 may include a wireless connection 116 to the communications network 108, to which the electronic gaming machine 102 is also connected. Hence, the wireless remote control unit 104 can receive data from and send data to the electronic gaming machine 102 via the wireless connection 116.

In one example, the electronic gaming machine 102 may be a small-form-factor personal computer that creates and broadcasts an encrypted wireless network. As such, the electronic gaming machine may facilitate a paired and highly secured (e.g., encrypted) connection to the wireless remote control unit 104.

Additionally, in some embodiments, the electronic gaming machine 102 and/or the wireless remote control unit 104 can communicate with other networked computing devices via the communications network 108. For instance, the electronic gaming machine could communicate with a gaming server (not shown). As another example, the wireless remote control unit 104 could communicate with a payment processor (also not shown).

In some examples, multiple players can play a multiplayer game using the electronic gaming machine 102. For instance, there may be multiple wireless remote control units wirelessly connected to the electronic gaming machine 102 (e.g., via network 108) from which different respective players can play the wager game. Such multiplayer functionality may enable wager games such as blackjack, where the players' cards could be displayed on the wireless remote control units and the dealers cards could be displayed on the display device. As another example, during a game of roulette, the wireless remote control units could be used to place and confirm bets and the display device could be used to display a roulette table, wheel, and gaming action.

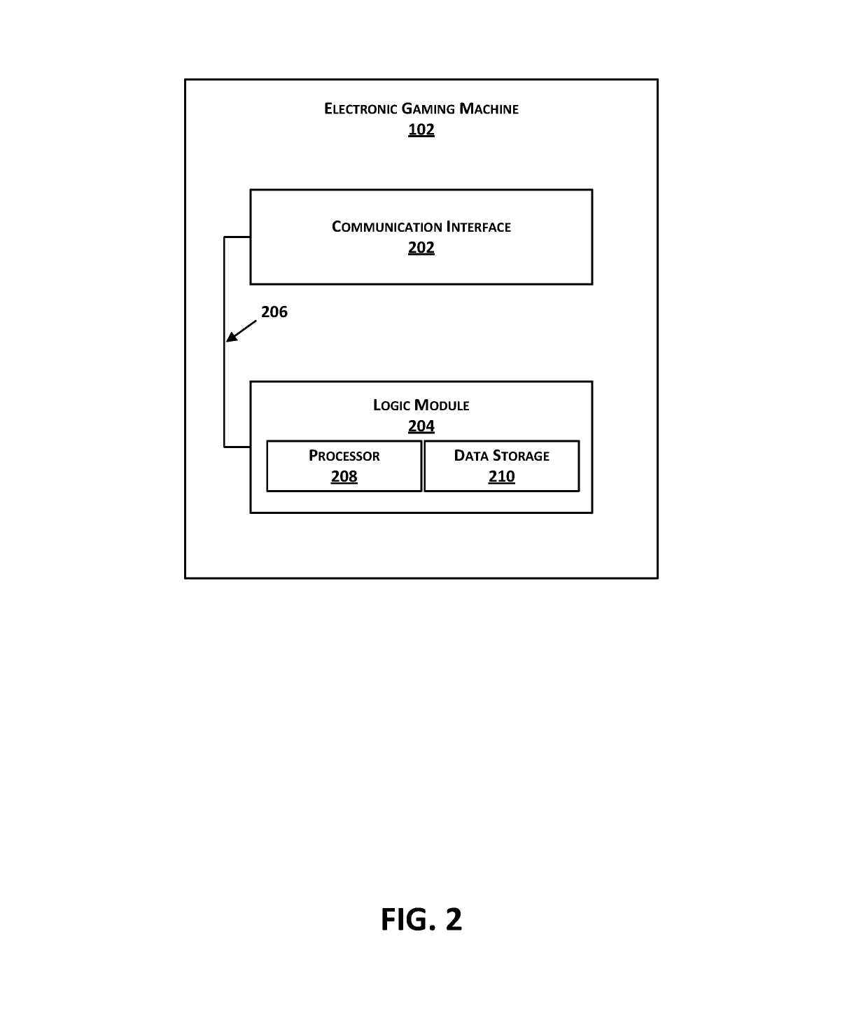

FIG. 2 is a simplified block diagram of an example embodiment of the electronic gaming machine 102. As shown in FIG. 2, the electronic gaming machine 102 may include a communication interface 202 and a logic module 204, which may be coupled together by a system bus, network, or other connection mechanism 206.

The communication interface 202 may include a wired and/or wireless network communication interface. For purposes of this description, any data described as being provided, sent, or transmitted by the electronic gaming machine 102 can be data sent by communication interface 202 over a communication network. Also, for purposes of this description, any data described as being received by the electronic gaming machine 102 can be data sent to communication interface 202 over a communication network. In some examples, the electronic gaming machine 102 may include multiple communication interfaces (not shown). For instance, the electronic gaming machine may include a first communication interface for communicating with a wireless remote control unit (such as the wireless remote control unit 104 of FIG. 1) and a second communication interface for communicating with a display device (such as the display device 106 of FIG. 1). In one embodiment, the first communication interface can be a wireless network adapter and the second communication interface can be a video port.

The logic module 204 can take the form of a processor 208 and a data storage 210. The processor 208 can include a general-purpose processor (e.g., a microprocessor) or a special-purpose processor (e.g., a digital signal processor or an application specific integrated circuit) and may be integrated in whole or in part with the communication interface 202. Any data storage discussed in this description or shown in the drawings can be referred to as computer-readable data storage.

Data storage 210 may include volatile or non-volatile storage components and may be integrated in whole or in part with processor 208. Data storage 210 may take the form of a non-transitory computer-readable medium and may include software program instructions, that when executed by processor 208, cause the electronic gaming machine 102 to perform one or more of the operations described herein. For instance, data storage 210 may include software instructions for executing one or more wager games and for generating image data for one or more wager games. Further, data storage may include software instructions for sending image data to a display device (such as the display device 106 of FIG. 1). Any software program instructions discussed in this description or shown in the drawings can be referred to as computer-readable program instructions, or more simply, program instructions.

Data storage 210 may also include operating system software on which the electronic gaming machine 102 may operate. For example, the electronic gaming machine 102 may operate on a Windows®-based operating system (e.g., Windows 7 or Windows 10) provided by the Microsoft® Corporation of Redmond, Wash. Other examples of operating systems are possible.

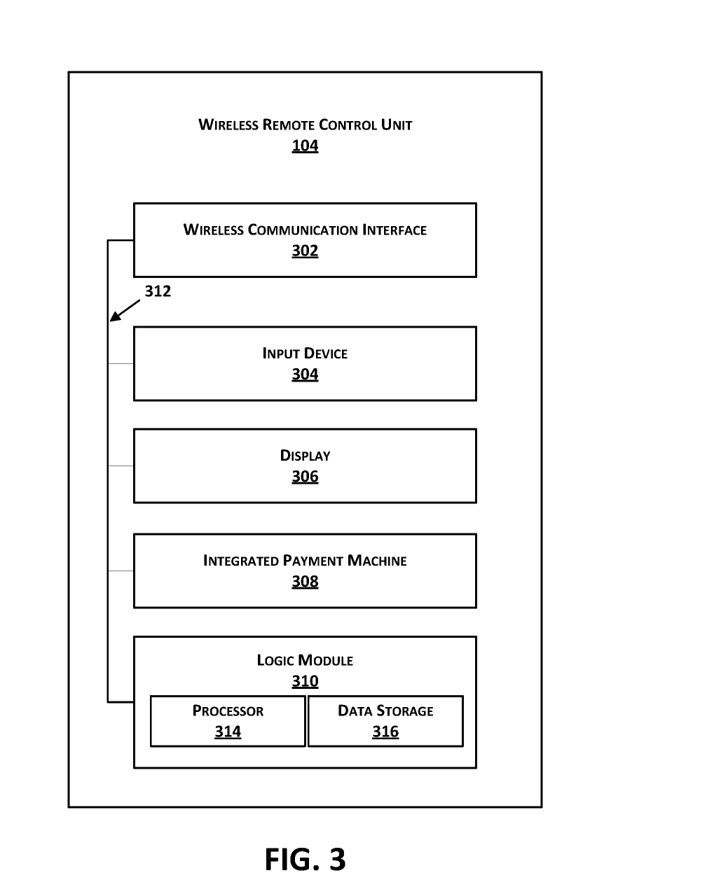

FIG. 3 is a simplified block diagram of an example embodiment of the wireless remote control unit 104. As shown in FIG. 3, the wireless remote control unit 104 may include a wireless communication interface 302, an input device 304, a display 306, an integrated payment machine 308, and a logic module 310, all of which may be coupled together by a system bus, network, or other connection mechanism 312.

For purposes of this description, any data described as being provided, sent, or transmitted by the wireless remote control unit 104 can be data sent by wireless communication interface 302 over a communication network. Also, for purposes of this description, any data described as being received by the wireless remote control unit 104 can be data sent to wireless communication interface 302 over a communication network.

In operation, the wireless remote control unit 104 may be configured to connect to a specific wireless network broadcast by the electronic gaming machine 102, using the wireless communication interface 302. Upon identifying the wireless network, the wireless remote control unit 104 may register itself with the wireless network as a remote button panel.

The input device 304 can include a keypad, trackpad, touchpad, touchscreen, and/or other device that can receive input from a user. For instance, the input device 304 can take the form of a touchscreen overlaying the display 306. In some embodiments, the input device 304 can take the form of one or any combination of physical button(s), an analog stick (e.g., a joystick or thumb stick), and a directional pad.

The display 306 can take the form of any type of a flat or curved panel display, such as a liquid crystal display or organic light-emitting diode (OLED) display. In some embodiments, the wireless remote control unit 104 may include mechanical buttons instead of a display (not shown).

The integrated payment machine 308 can take the form of a card reader or other device capable of receiving details of a payment instrument. The integrated payment machine 308 may also include an authentication component configured to verify a user's identity, such as a thumbprint reader or a facial recognition scanner.

The logic module 310 can take the form of a processor 314 and a data storage 316. The processor 314 can include a general-purpose processor (e.g., a microprocessor) or a special-purpose processor (e.g., a digital signal processor or an application specific integrated circuit) and may be integrated in whole or in part with the wireless communication interface 302, input device 304, display 306, and/or integrated payment machine 308.

Data storage 316 may include volatile or non-volatile storage components and may be integrated in whole or in part with processor 314. Data storage 316 may take the form of a non-transitory computer-readable medium and may include software program instructions, that when executed by processor 314, cause the wireless remote control unit 104 to perform one or more of the operations described herein. For instance, data storage 316 may include software instructions for establishing communication with an electronic gaming machine, and displaying at least one game-play option for a particular wager game. Further, data storage 316 may include software instructions for receiving data indicative of a game-play command for the particular wager game, and sending to the electronic gaming machine instructions for carrying out the game-play command.

Data storage 316 may also include operating system software on which the wireless remote control unit 104 may operate. For example, the wireless remote control unit 104 may operate on a Windows®-based operating system (e.g., Windows 7 or Windows 10) provided by the Microsoft® Corporation of Redmond, Wash. Other examples of operating systems are possible.

### III. Example Operation—Selecting a Wager Game

A user may select a wager game to play using the wireless remote control unit 104. By way of example, the wireless remote control unit 104 may store a list of wager games that the electronic gaming machine 102 is configured to run in data storage 314. Upon start up, or at another time, the wireless remote control unit 104 may display the list of wager games via the display 306. The user can then browse through the list of wager games using the input device 304, and select a particular wager game to play. For example, the wireless remote control unit 104 may display a graphical lobby of available wager games on the electronic gaming machine 102.

In response to receiving a selection of the particular wager game, the wireless remote control unit 104 may send to the electronic gaming machine 102, via the wireless communication interface 302, instructions for initiating the particular wager game. The instructions may identify the particular wager game, for instance.

Once a player selects a wager game, the electronic gaming machine 102 may load the wager game and the wireless remote control unit 104 may load a button panel for the wager game. The player can then play the wager game via the wireless remote control unit 102 instead of playing the wager game via a button panel that is physically attached to the electronic gaming machine 102. The player may be able to accomplish via the wireless remote control unit tasks (e.g., wagering, spinning, drawing, etc.) that the player would normally accomplish using a button panel that is physically attached to an electronic gaming machine 102.

Similarly, the wireless remote control unit 104 may display a game-play option that allows a user to end a wager game and switch to another game. For instance, the wireless remote control unit 104 may display an end-game option or a return-to-home option, and in response to receiving data indicative of a selection of the end-game option or return-to-home option, the wireless remote control unit 104 may display the list of wager games. As a specific example, the player may be able to exit a wager game using the input device 304 and return to the graphical lobby to choose another game.

In some instances, the wireless remote control unit 104 may include a geolocation component, such as a GPS receiver. Further, the electronic gaming machine 102 and/or the wireless remote control unit 104 may be configured to monitor the geographic location of the wireless remote control unit 104 using geographic location reports provided by the geolocation component. If the electronic gaming machine 102 and/or the wireless remote control unit 104 detects that wireless remote control unit is located outside of a predefined distance from a location of the electronic gaming machine 102, the electronic gaming machine 102 and/or the wireless remote control unit 104 may disable the ability to play wager games on the wireless remote control unit 104.

### IV. Example Operation—Selecting a Game-Play Option

When a user is playing a wager game, the wireless control unit 104 may display various game-play options. As one example, when playing a slot machine game, the wireless control unit 104 may display via display 306 a spin option. A user may select the spin option to spin one or more reels. In response to receiving data indicative of a selection of the spin option, the wireless remote control unit 104 may send a spin command to the electronic gaming machine. The electronic gaming machine may then update the state of the wager game, and generate image data corresponding to the updated state for display on the display device 106.

As another example, when playing a slot machine game, the wireless control unit 104 may display via display 306 various wager-size options and a make-wager option. For instance, the wireless remote control unit 104 may display a 1-dollar option, a 5-dollar option, and a max-bet option, as well as a make-wager option. A user may select a desired wager using the wager-size options, and after selecting the desired wager size, select the make-wager option. In response to receiving data indicative of a selection of the make-wager option, the wireless remote control unit 104 may then send a command indicative of the selective wager size to the electronic gaming machine.

In some examples, the wireless remote control unit 104 may display multiple game-play options related to decisions in a wager game. For instance, when playing blackjack, the wireless control unit 104 may display a hit option and a stand option. A user may look at the display device 106 to view the user's hand and the dealer's hand, and select either the hit option to draw another card or the stand option to stand pat. In response to receiving data indicative of the selected game-play option, the wireless remote control unit 104 may then send a game-play command indicative of the selected game-play option to the electronic gaming machine.

### V. Example Operation—Adding Funds to a Wager Account

In some examples, each user may have a wager account with a casino. Users may add funds to their respective wager accounts using a computing device in the casino. For instance, a user may go to the computing device, input information identifying the user (e.g., a casino player's card), insert a credit or debit card, and select an amount of funds to add to the user's wager account.

Alternatively or additionally, a user can add funds to the user's wager account using the integrated payment machine 308 on the wireless remote control unit 104. By way of example, when a user is playing a wager game (or before or after a user plays a wager game), the wireless remote control unit 104 may display via display 306 an add-funds option. A user may select the add-funds option using the input device 304 to add funds to the user's wager account. In response to receiving data indicative of a selection of the add-funds option, the wireless remote control unit 104 may display a notification prompting the user to provide details of a payment instrument via the integrated payment machine 308. For instance, if the integrated payment machine 308 is a card reader, the notification may prompt the user to tap an NFC device to the card reader, slide a card through the card reader, or insert a card into the card reader. The notification may also prompt the user to select an amount of funds to add to the user's wager account. The user can then tap an NFC device to the card reader or slide/insert a credit or debit card and select a desired amount of funds.

In response to receiving details of a payment instrument via the integrated payment machine, the wireless remote control unit may initiate a transfer of electronic funds to the user's wager account. For instance, the integrated payment machine may provide one or more instructions to a payment processor using an application programming interface of the payment processor. The instructions may be wirelessly sent to the payment processor over a communications network, such as a wireless network provided by a casino to which the wireless remote control unit is connected.

### VI. Additional Example Operations

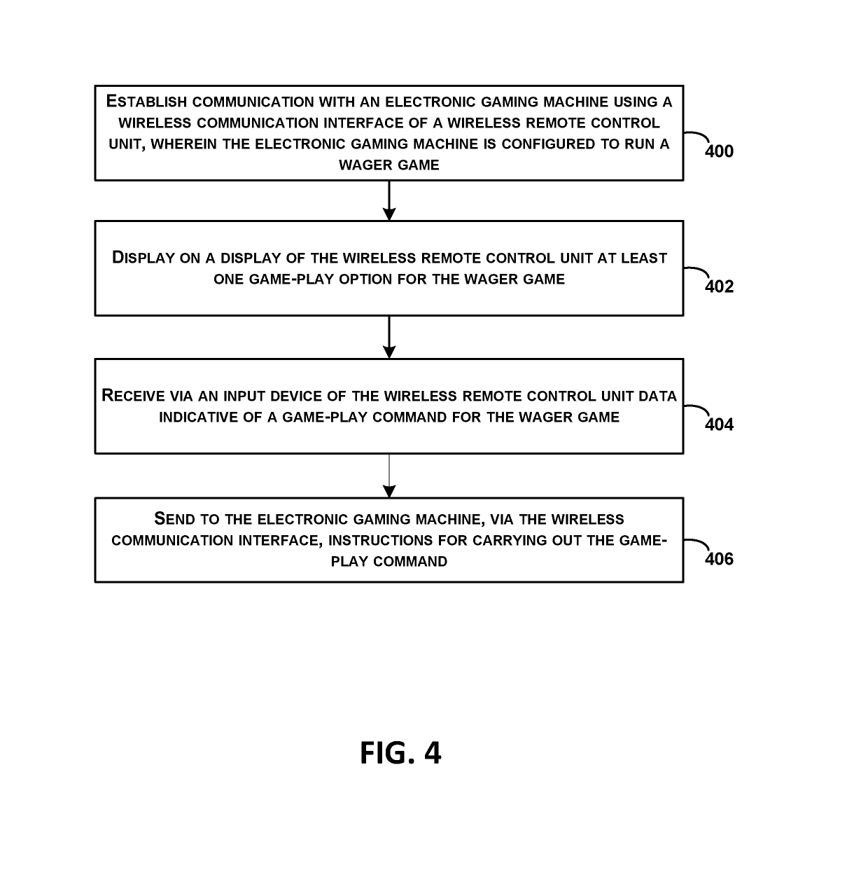

FIG. 4 depicts a flow chart showing a set of operations that can, for example, be carried out using a wireless remote control unit, such as the wireless remote control unit 104.

Initially, block 400 includes establishing communication with an electronic gaming machine using a wireless communication interface of a wireless remote control unit. The electronic gaming machine is configured to run a wager game.

Next, block 402 includes displaying on a display of the wireless remote control unit at least one game-play option for the wager game. In some embodiments, the at least one game-play option may include at least one wagering option. For instance, the at least one wager option may include a wager-size option and a make-wager option. Additionally or alternatively, the at least one game-play option may include multiple game-play options.

Next, block 404 includes receiving via an input device of the wireless remote control unit data indicative of a game-play command for the wager game. In some embodiments, the data indicative of the game-play command may include data indicative of a selection of a wager size and a selection of a make-wager option. In some embodiments, the data indicative of the game-play command may include data indicative of a selection of one of multiple game-play options.

Next, block 406 includes sending to the electronic gaming machine, via the wireless communication interface, instructions for carrying out the game-play command.

### VII. Additional Example Embodiments

The following clauses are offered as further description of the disclosed embodiments.

(1) A wireless remote control unit comprising:

a wireless communication interface;

an input device;

a display;

a processing unit; and

data storage comprising instructions executable by the processing unit to carry out operations comprising:

establishing communication with an electronic gaming machine using the wireless communication interface,

displaying on the display at least one game-play option for a particular wager game on the electronic gaming machine,

receiving via the input device data indicative of a game-play command for the particular wager game, and

sending to the electronic gaming machine, via the wireless communication interface, instructions for carrying out the game-play command.

(2) The wireless remote control unit of clause (1), further comprising an integrated payment machine configured to receive details of a payment instrument.

(3) The wireless remote control unit of clause (2), wherein the operations further comprise:

receiving via the integrated payment machine the details of the payment instrument; and

in response to receiving the details of the payment instrument, initiating a transfer of electronic funds to a wager account of a user of the wireless remote control unit.

(4) The wireless remote control unit of any of clauses (2)-(3), wherein the operations further comprise:

displaying on the display an add-funds option;

receiving via the input device data indicative of a selection of the add-funds option; and

in response to receiving the data indicative of the selection of the add-funds option, displaying on the display a notification, wherein the notification comprises a prompt to provide the details of the payment instrument via the integrated payment machine.

(5) The wireless remote control unit of any of clauses (1)-(4), wherein the at least one game-play option comprises at least one wagering option.

(6) The wireless remote control unit of any of clauses (1)-(5), wherein the at least one wagering option comprises a wager-size option and a make-wager option, and wherein the data indicative of the game-play command comprises data indicative of a selection of a wager size and a selection of the make-wager option.

(7) The wireless remote control unit of any of clauses (1)-(6), wherein the at least one game-play option comprises multiple game-play options, and wherein the data indicative of the game-play command comprises data indicative of a selection of one of the multiple game-play options.

(8) The wireless remote control unit of any of clauses (1)-(7), wherein the input device comprises a touchscreen.

(9) The wireless remote control unit of clause (8), wherein the touchscreen is layered on top of the display.

(10) The wireless remote control unit of any of clauses (1)-(9), wherein the operations further comprise:

receiving via the input device data indicative of a selection of the particular wager game from among a plurality of wager games that the electronic gaming machine is configured to run; and

in response to receiving the data indicative of the selection of the particular wager game, sending to the electronic gaming machine, via the wireless communication interface, instructions for initiating the particular wager game.

(11) A system comprising:

a display device;

an electronic gaming machine configured to run one or more wager games, wherein the electronic gaming machine is configured to generate image data for display on the display device for the one or more wager games, and wherein the electronic gaming machine comprises a network communication interface; and

a wireless remote control unit comprising a wireless communication interface, an input device, and a remote control unit display, wherein the wireless remote control unit is configured to:

display on the remote control unit display at least one game-play option for a particular wager game on the electronic gaming machine,

receive via the input device data indicative of a game-play command for the particular wager game, and

send to the electronic gaming machine, via the wireless communication interface of the wireless remote control unit, instructions for carrying out the game-play command.

(12) The system of clause (11), wherein the electronic gaming machine is coupled to the display device via a wired or wireless connection.

(13) The system of any of clauses (11)-(12), wherein the display device comprises a television.

(14) The system of any of clauses (11)-(12), wherein the display device comprises a computer monitor.

(15) The system of any of clauses (11)-(12), wherein the display device comprises an image projector.

(16) The system of any of clauses (11)-(15), wherein the wireless remote control unit further comprises an integrated payment machine configured to receive details of a payment instrument.

(17) The system of any of clauses (11)-(16), wherein the at least one game-play option comprises at least one wagering option.

(18) The system of any of clauses (11)-(17), wherein the input device of the wireless remote control unit comprises a touchscreen.

(19) A method for playing a wager game, the method comprising:

establishing communication with an electronic gaming machine using a wireless communication interface of a wireless remote control unit, wherein the electronic gaming machine is configured to run the wager game;

displaying on a display of the wireless remote control unit at least one game-play option for the wager game;

receiving via an input device of the wireless remote control unit data indicative of a game-play command for the wager game, and

sending to the electronic gaming machine, via the wireless communication interface, instructions for carrying out the game-play command.

(20) The method of clause (19), further comprising:

receiving via an integrated payment machine of the wireless remote control unit details of a payment instrument; and

in response to receiving the details of the payment instrument, initiating a transfer of electronic funds to a wager account of a user of the wireless remote control unit.

(21) The method of any of clauses (19)-(20), wherein the electronic gaming machine is configured to run a plurality of wager games, and wherein the method further comprises:

receiving via the input device data indicative a selection of the wager game from among the plurality of wager games; and

in response to receiving the data indicative of the selection of the wager game, sending to the electronic gaming machine, via the wireless communication interface, instructions for initiating the wager game.

### VIII. Conclusion

This detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be used, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including in substantially concurrent or in reverse order, depending on the functionality involved. Further, more or fewer steps, blocks and/or functions can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer-readable medium such as a storage device including a disk or hard drive or other storage media.

The computer-readable medium can include non-transitory computer-readable media such as computer-readable media that stores data for short periods of time like register memory, processor cache, and/or random access memory (RAM). The computer-readable media can include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media can be any other volatile or non-volatile storage systems. A computer-readable medium can be considered a computer-readable storage medium, for example, or a tangible storage device.

Software for use in carrying out the invention can also be in transitory form, for example in the form of signals transmitted over a network such as the Internet. Moreover, a step or block that represents one or more information transmissions can correspond to information transmissions between software and/or hardware modules in the same physical device. However, other information transmissions can be between software modules and/or hardware modules in different physical devices.

Further, the described operations throughout this application need not be performed in the disclosed order, although in some examples, the recited order may be preferred. Also, not all operations need to be performed to achieve the desired advantages of disclosed machines and methods, and therefore not all operations are required.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

While examples have been described in terms of select embodiments, alterations and permutations of these embodiments will be apparent to those of ordinary skill in the art. Other changes, substitutions, and alterations are also possible without departing from the disclosed machines and methods in their broader aspects as set forth in the following claims.

What is claimed is:

1. A wireless remote control unit comprising:
a wireless communication interface;
an input device;
a display;
a processing unit; and
data storage comprising instructions executable by the processing unit to carry out operations comprising:
establishing communication with an electronic gaming machine using the wireless communication interface,
displaying on the display at least one game-play option for a particular wager game on the electronic gaming machine,
receiving via the input device data indicative of a game-play command for the particular wager game, and
sending to the electronic gaming machine, via the wireless communication interface, instructions for carrying out the game-play command.

2. The wireless remote control unit of claim 1, further comprising an integrated payment machine configured to receive details of a payment instrument.

3. The wireless remote control unit of claim 2, wherein the operations further comprise:
receiving via the integrated payment machine the details of the payment instrument; and
in response to receiving the details of the payment instrument, initiating a transfer of electronic funds to a wager account of a user of the wireless remote control unit.

4. The wireless remote control unit of claim 3, wherein the operations further comprise:
displaying on the display an add-funds option;
receiving via the input device data indicative of a selection of the add-funds option; and
in response to receiving the data indicative of the selection of the add-funds option, displaying on the display a notification, wherein the notification comprises a prompt to provide the details of the payment instrument via the integrated payment machine.

5. The wireless remote control unit of claim 1, wherein the at least one game-play option comprises at least one wagering option.

6. The wireless remote control unit of claim 1, wherein the at least one wagering option comprises a wager-size option and a make-wager option, and wherein the data indicative of the game-play command comprises data indicative of a selection of a wager size and a selection of the make-wager option.

7. The wireless remote control unit of claim 1, wherein the at least one game-play option comprises multiple game-play options, and wherein the data indicative of the game-play command comprises data indicative of a selection of one of the multiple game-play options.

8. The wireless remote control unit of claim 1, wherein the input device comprises a touchscreen.

9. The wireless remote control unit of claim 8, wherein the touchscreen is layered on top of the display.

10. The wireless remote control unit of claim 1, wherein the operations further comprise:
receiving via the input device data indicative of a selection of the particular wager game from among a plurality of wager games that the electronic gaming machine is configured to run; and
in response to receiving the data indicative of the selection of the particular wager game, sending to the electronic gaming machine, via the wireless communication interface, instructions for initiating the particular wager game.

11. A system comprising:
a display device;
an electronic gaming machine configured to run one or more wager games, wherein the electronic gaming machine is configured to generate image data for display on the display device for the one or more wager games, and wherein the electronic gaming machine comprises a network communication interface; and
a wireless remote control unit comprising a wireless communication interface, an input device, and a remote control unit display, wherein the wireless remote control unit is configured to:
display on the remote control unit display at least one game-play option for a particular wager game on the electronic gaming machine,
receive via the input device data indicative of a game-play command for the particular wager game, and
send to the electronic gaming machine, via the wireless communication interface of the wireless remote control unit, instructions for carrying out the game-play command.

12. The system of claim 11, wherein the electronic gaming machine is coupled to the display device via a wired or wireless connection.

13. The system of claim 11, wherein the display device comprises a television.

14. The system of claim 11, wherein the display device comprises a computer monitor.

15. The system of claim 11, wherein the display device comprises an image projector.

16. The system of claim 11, wherein the wireless remote control unit further comprises an integrated payment machine configured to receive details of a payment instrument.

17. The system of claim 11, wherein the at least one game-play option comprises at least one wagering option.

18. A method for playing a wager game, the method comprising:
establishing communication with an electronic gaming machine using a wireless communication interface of a wireless remote control unit, wherein the electronic gaming machine is configured to run the wager game;
displaying on a display of the wireless remote control unit at least one game-play option for the wager game;
receiving via an input device of the wireless remote control unit data indicative of a game-play command for the wager game; and
sending to the electronic gaming machine, via the wireless communication interface, instructions for carrying out the game-play command.

19. The method of claim 18, further comprising:
receiving via an integrated payment machine of the wireless remote control unit details of a payment instrument; and
in response to receiving the details of the payment instrument, initiating a transfer of electronic funds to a wager account of a user of the wireless remote control unit.

20. The method of claim 18, wherein the electronic gaming machine is configured to run a plurality of wager games, and wherein the method further comprises:
receiving via the input device data indicative a selection of the wager game from among the plurality of wager games; and
in response to receiving the data indicative of the selection of the wager game, sending to the electronic gaming machine, via the wireless communication interface, instructions for initiating the wager game.
